(19) United States
(12) Patent Application Publication
(10) Pub. No.: US 2014/0334036 A1
(43) Pub. Date: Nov. 13, 2014

(54) ROTATING DEVICE

(71) Applicant: Samsung Electro-Mechanics Japan Advanced Technology Co., Ltd., Shizuoka (JP)

(72) Inventor: Hirotake NISHINO, Shizuoka (JP)

(73) Assignee: Samsung Electro-Mechanics Japan Advanced Technology Co., Ltd., Shizuoka (JP)

(21) Appl. No.: 14/269,581

(22) Filed: May 5, 2014

(30) Foreign Application Priority Data
May 9, 2013 (JP) 2013-099289

(51) Int. Cl. G11B 19/20

(52) U.S. Cl. CPC G11B 19/2036
USPC 360/99.12

(57) ABSTRACT

A rotating device comprises: a rotor comprising: a hub on which a magnetic recording disk is to be mounted; a shaft extending along a rotational axis of the hub, one side of the shaft being fixed to the hub; a flange surrounding the other side of the shaft, the flange being fixed to the shaft; and a shaft support member surrounding the shaft and rotatably supporting the shaft. A lubricant agent is interposed between the shaft and the shaft support member. The gas-liquid interface of the lubricant agent is provided in a gap between the shaft and the shaft support member. The hub includes a surrounding portion which surrounds the shaft support member. A gap defined between the surrounding portion and the shaft support member communicates with the gas side of the gas-liquid interface. The gap thus defined is positioned radially inward from the outer face of the flange.

### REFERENCE TO RELATED APPLICATION

The present application claims the benefit of Japanese Patent Application No. 2013-099289, filed May 9, 2013, whose disclosure is hereby incorporated by reference in its entirety into the present disclosure.

### BACKGROUND OF THE INVENTION

1. Field of the Invention

The present invention relates to a rotating device which rotationally drives a magnetic recording disk.

2. Description of the Related Art

As an example of a rotating device, disk drive apparatuses such as hard disk drives are known. Progress is being made in reducing the size and increasing the data capacity of a disk drive apparatus. For example, 3.5-inch hard disk drives having a data capacity on the order of 4.0 TB have become available. Previously, such a hard disk drive apparatus has mainly been mounted in a desktop personal computer. However, such progress in hard disk drives has led to a trend of various kinds of electronic devices such as laptop PCs, recording devices, etc., mounting such a disk drive apparatus. The rise in popularity of large-volume content such as High-Definition video images has led to a demand for such a disk drive apparatus having a further increased data capacity (see Patent Application Laid Open No. 2011-103150, for example).

As a bearing of such a disk drive apparatus, a fluid dynamic bearing is known. With such a fluid dynamic bearing, a lubricant agent is injected into a gap between a rotor and a stator. By means of dynamic pressure that occurs in the lubricant agent when the rotor is rotated with respect to the stator, the fluid dynamic bearing maintains a contactless state between the rotor and the stator.

### SUMMARY OF THE INVENTION

As a method for improving the capacity of such a disk drive apparatus, a method is known in which the width of each recording track is narrowed and the distance between a magnetic head and the surface of a magnetic recording disk is further reduced. In a case in which the gap between the magnetic head and the surface of the magnetic recording disk is reduced, this leads to a marked increase in adverse effects on the read/write performance due to contaminants adhered to the surface of the magnetic recording disk.

Moreover, with disk drive apparatuses employing such a fluid dynamic bearing, the quantity of evaporation of the lubricant agent increases with the passage of time, and the evaporated lubricant agent tends to adhere to the magnetic recording disk. In addition, if the quantity of the lubricant agent markedly falls, in some cases, this degrades the performance of the fluid dynamic bearing.

Such problems are not restricted to disk drive apparatuses. Rather, such problems can occur in various other kinds of rotating devices.

The present invention has been made in view of such a situation. Accordingly, it is a general purpose of the present invention to provide a rotating device which is capable of reducing the amount of evaporation of a lubricant agent injected into a fluid dynamic bearing.

A rotating device according to an embodiment comprises: a hub on which a magnetic recording disk is to be mounted; a shaft extending along a rotational axis of the hub, one side of the shaft being fixed to the hub; a flange surrounding the other side of the shaft, the flange being fixed to the shaft; and a bearing body surrounding the shaft and rotatably supporting the shaft. A lubricant agent is interposed between the shaft and the bearing body. The gas-liquid interface of the lubricant agent is provided in a gap between the shaft and the bearing body. The hub includes a surrounding portion which surrounds the bearing body. The gap between the surrounding portion and the bearing body communicates with the gas side of the gas-liquid interface. The gap is positioned radially inward from the outer face of the flange.

Another embodiment of the present invention also relates to a rotating device. The rotating device comprises: a hub on which a magnetic recording disk is to be mounted; a shaft extending along a rotational axis of the hub, one side of the shaft being fixed to the hub; and a bearing body surrounding the shaft and rotatably supporting the shaft. The bearing body comprises an annular portion located in an end of the bearing body on said one side, an outer peripheral surface of the annular portion being recessed radially inward. The annular portion axially passes through a center hole of the magnetic recording disk.

Optional combinations of the aforementioned constituting elements and implementations of the invention in the form of methods, apparatuses, or systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A and 1B are a top view and a side view each showing a rotating device according to a first embodiment;

FIG. 2 is a cross-sectional view taken along line A-A;

FIGS. 3A and 3B each show a top view of a laminated core;

FIG. 4 is a diagram showing vibration spectrums of the rotating device according to the first embodiment and a rotating device according to a comparison example;

FIG. 5 is a diagram showing vibration spectrums of the rotating device according to the first embodiment and the rotating device according to the comparison example;

FIG. 6 is a cross-sectional view showing a rotating device according to a second embodiment; and

FIG. 7 is an explanatory diagram for describing the structures of a tapered sealing portion and the gap between a shaft support member and a hub included in the rotating device according to the first embodiment.

### DETAILED DESCRIPTION OF THE INVENTION

The invention will now be described by reference to the preferred embodiments. This does not intend to limit the scope of the present invention but to exemplify the invention. The size of the component in each figure may be changed in order to aid understanding. Some of the components in each figure may be omitted if they are not important for explanation.

A rotating device according to an embodiment may preferably be employed as a disk driving apparatus, and particularly, as a hard disk drive mounting a magnetic recording disk and configured to rotationally drive the magnetic recording disk.

### First Embodiment

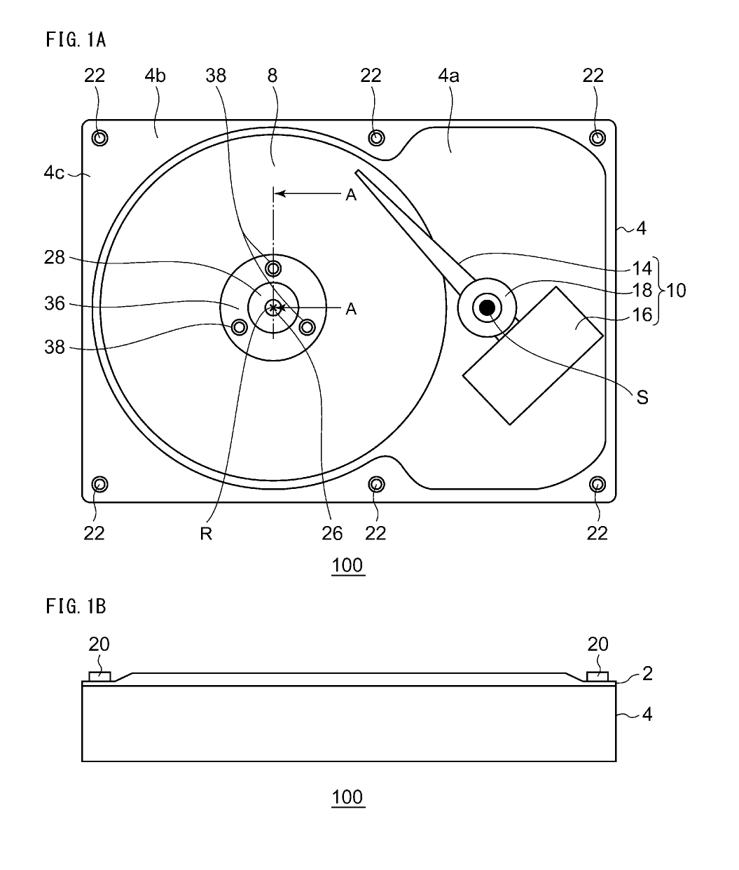

FIGS. 1A and 1B each show a rotating device 100 according to a first embodiment. FIG. 1A is a top view of the rotating device 100. FIG. 1B is a side view of the rotating device 100. In order to show the internal structure of the rotating device 100, FIG. 1A shows a state without a top cover 2. The rotating device 100 includes a stator, a rotor which rotates with respect to the stator, a magnetic recording disk 8 mounted on the rotor, and a data read/write unit 10. The stator includes a base 4, a top cover 2, and six screws 20. The rotor includes a shaft 26, a hub 28, a clamper 36, and three clamp screws 38.

Description will be made below with the side of the base 4 on which the hub 28 is mounted as the upper side.

The magnetic recording disk 8 is configured as a 3.5-inch magnetic recording disk formed of an aluminum disk having a diameter of approximately 95 mm, which has a central hole having a diameter of approximately 25 mm, and which has a thickness of approximately 1.27 mm or approximately 1.75 mm. The magnetic recording disk 8 is mounted on the hub 28, and is rotated according to the rotation of the hub 28.

The base 4 is formed by molding an aluminum alloy material by means of die casting. The base 4 includes a bottom portion 4a that defines the bottom of the rotating device 100, and an outer wall portion 4b formed along the outer edge of the bottom portion 4a so as to surround a mounting region on which the magnetic recording disk 8 is to be mounted. Six screw holes 22 are formed in an upper face 4c of the outer wall portion 4b. Also, the base 4 may be formed by press forming a steel plate or aluminum plate. In this case, the base 4 may be provided with an embossed portion having a structure in which a protrusion is formed on one face of the base 4 by pressing upward, which provides the other face with a recess. By providing such an embossed portion to a predetermined portion of the base 4, such an arrangement is capable of suppressing deformation of the base 4.

In order to prevent the detachment of the surface layer of the base 4, the base 4 is subjected to surface coating. The surface coating may be performed using a resin material such as epoxy resin or the like, for example. Alternatively, the surface coating may be performed by plating the surface of the base 4 with a metal material such as nickel, chrome, or the like. With the present embodiment, the surface of the base 4 is subjected to electroless nickel plating. Such an arrangement allows the surface of the base 4 to have a high hardness and a low friction coefficient, as compared with the surface of the base 4 subjected to resin coating. Furthermore, such an arrangement reduces a risk of damage of the surface of the base 4 or the magnetic recording disk 8 even if the magnetic recording disk 8 comes in contact with the surface of the base 4 in the manufacturing, for example. With the present embodiment, the surface of the base 4 is formed to have a static friction coefficient ranging between 0.1 and 0.6. Such an arrangement further reduces a risk of damage of the base 4 or the magnetic recording disk 8, as compared with the surface of the base 4 having a static friction coefficient of 2 or more.

The data read/write unit 10 includes a record and playback head (not shown), a swing arm 14, a voice coil motor 16, and a pivot assembly 18. The record and playback head is arranged at the end of the swing arm 14, and is configured to record data on the magnetic recording disk 8, and to read out data from the magnetic recording disk 8. The pivot assembly 18 supports the swing arm 14 such that it can be freely swung around the head rotational axis S with respect to the base 4. The voice coil motor 16 swings the swing arm 14 around the head rotational axis S, such that the record and playback head is shifted to a desired position above the face of the magnetic recording disk 8. The voice coil motor 16 and the pivot assembly 18 are each configured using known techniques for controlling the head position.

The top cover 2 is fixedly arranged on the upper face 4c of the outer wall portion 4b of the base 4 using the six screws 20. The six screws 20 respectively correspond to the six screw holes 22. Specifically, the top cover 2 and the upper face 4c of the outer wall portion 4b are fixedly coupled to each other such that no leaks to the interior of the rotating device 100 arise via the connection between them.

The shaft 26 is arranged such that it extends with the rotational axis R of the hub 28 as its center axis. The upper end of the shaft 26 is fixed with respect to the hub 28 as described later.

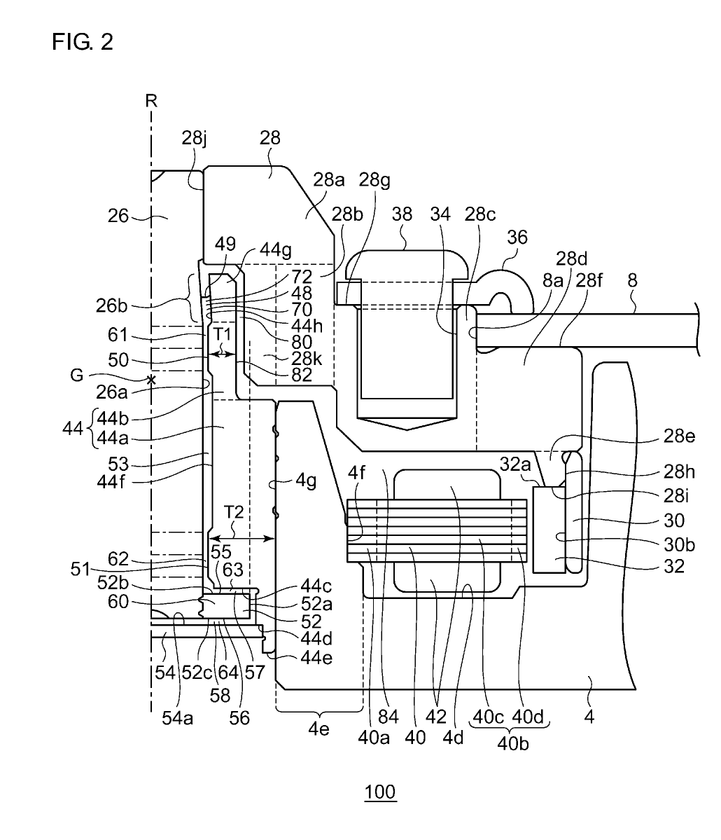

FIG. 2 is a cross-sectional view taken along line A-A in FIG. 1A.

The rotor further includes a circular yoke 30, a cylindrical magnet 32, and a flange 52. The stator further includes a shaft support member 44, a laminated core 40, a coil 42, and a counter plate 54. The lubricant agent 48 is continuously interposed in a part of the gap between the rotor and the stator.

The hub 28 is formed by cutting a forged aluminum alloy product such as A6061 or the like, for example. The hub 28 is formed to have a predetermined shape, i.e., an approximately cup-shaped form. In order to prevent the detachment of the surface layer of the hub 28, the hub 28 is subjected to surface coating. The surface coating may be performed using a resin material such as epoxy resin or the like, for example. Also, the surface coating may be performed by plating the surface of the hub 28 with a metal material such as nickel, chrome, or the like, for example. Alternatively, the surface coating may be performed by forming an anodized aluminum layer on the surface. With the present embodiment, the surface of the hub 28 is subjected to electroless nickel plating.

The hub 28 includes a shaft fixation portion 28a which surrounds the upper end side of the shaft 26, and which is fixed to the shaft 26; a surrounding portion 28b which is arranged radially outward from the shaft fixation portion 28a so as to surround the upper end side of the shaft support member 44; a disk fitting portion 28c which is arranged radially outward from the surrounding portion 28b such that it is fit to the central hole 8a of the magnetic recording disk 8; a mounting portion 28d which is arranged radially outward from the disk fitting portion 28c; and a downward protruding portion 28e configured such that it protrudes downward from the lower face of the mounting portion 28d so as to surround a circular wall portion 4e (described later).

The magnetic recording disk 8 is mounted on a disk mounting face 28f configured as the upper face of the mounting portion 28d. The clamper 36 is pressed in contact with the upper face 28g of the disk fitting portion 28c by means of the three clamp screws 38 screwed into three respective screw holes 34, thereby pressing the magnetic recording disk 8 into contact with the disk mounting face 28f.

The shaft 26 is fixed to a hole 28j provided at the center of the shaft fixation portion 28a by means of press fitting and adhesion, the hole 28j being arranged coaxially with the rotational axis R. The circular flange 52 is press fitted to the lower end of the shaft 26. The shaft 26 is formed by cutting a base steel material such as SUS420J2 or the like in a predetermined form, and by sintering and polishing the resulting member.

The cylindrical yoke 30 is fixedly bonded to an outer face 28h of the downward protruding portion 28e. The cylindrical yoke 30 is formed of a magnetic material such as iron or the like. The cylindrical magnet 32 is fixedly bonded to the inner face 30b of the cylindrical yoke 30 such that the upper end face 32a of the cylindrical magnet 32 abuts the lower end face 28i of the downward protruding portion 28e.

The cylindrical magnet 32 is formed of rare earth magnet materials or ferrite magnet materials, for example. With the present embodiment, the cylindrical magnet 32 is formed of neodymium rare earth magnet materials. The cylindrical magnet 32 is arranged such that it faces twelve salient poles provided to the laminated core 40 in the radial direction. The cylindrical magnet 32 is configured such that eight driving magnetic poles are formed in the circumferential direction (i.e., in a tangential direction of a circle, the center of which being in the rotational axis R and the circle being perpendicular to the rotational axis R). The cylindrical magnet 32 is subjected to anti-corrosion surface processing by means of electro-coating, spray coating, or the like.

The laminated core 40 has a circular portion 40a and twelve salient poles 40b, each protruding radially outward from the circular portion 40a, and is fixed on the upper face 4d side of the base 4. The laminated core 40 is formed by laminating and swaging seven thin magnetic steel sheets each having a thickness of 0.35 mm, so as to form a single member. Electrical insulating coating is applied to the surface of the laminated core 40 by means of electro-coating, powder coating, or the like. The twelve salient poles 40b each have an intermediate portion 40c configured such that it extends radially outward from the circular portion 40a, and an end portion 40d arranged on the side of the intermediate portion 40c that is opposite to the circular portion 40a. The coil 42 is wound around each intermediate portion 40c. By applying a three-phase driving current having an approximately sinusoidal waveform to the coil 42, such an arrangement is capable of generating a driving magnetic flux along each salient pole.

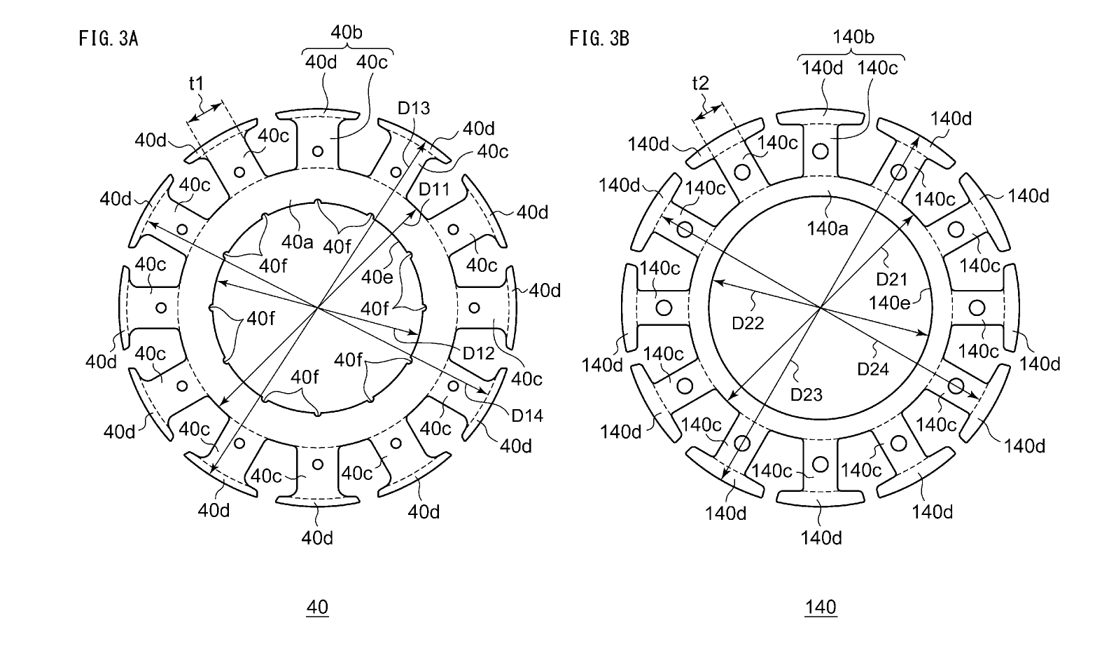

FIGS. 3A and 3B are top views each showing the laminated core. FIG. 3A shows the laminated core 40 according to the present embodiment. FIG. 3B shows a laminated core 140 according to a comparison example. With the laminated core 40 according to the present embodiment, grooves 40f, each configured as a recess that axially passes through the overall length of the circular portion 40a, are each formed in a straight-line form in the inner face 40e of the circular portion 40a at a position such that they correspond to the respective salient poles 40b. With the present embodiment, twelve grooves 40f are formed at regular circumferential intervals. This suppresses irregularities in the rotation of the rotor.

With the laminated core 140 according to the comparison example, the outer diameter D21 and the inner diameter D22 of the circular portion 140a and the circumferential thickness t2 of the intermediate portion 140c satisfy the following relation expressions.

0.835<D22/D21<0.841

0.127<t2/D21<0.133

In contrast, with the laminated core 40 according to the present embodiment is configured such that the outer diameter D11 and the inner diameter D12 of the circular portion 40a and the circumferential thickness t1 of the intermediate portion 40c satisfy the following relation expressions.

0.743<D12/D11<0.748

0.142<t1/D11<0.146

That is to say, the laminated core 40 is configured such that the radial thickness of the circular portion 40a and the ratio of the circumferential thickness t1 of the intermediate portion 40c with respect to the outer diameter D11 of the circular portion 40a are greater than the corresponding values of the laminated core 140.

Returning to FIG. 2, the base 4 includes a cylindrical ring-shaped wall portion 4e with the rotational axis R as its center axis. The ring-shaped wall portion 4e is configured such that it protrudes upward so as to surround the shaft support member 44. The laminated core 40 is fixedly bonded to the outer face 4f of the ring-shaped wall portion 4e by press fitting or otherwise by running fitting.

The shaft 26 is introduced into the shaft support member 44. The shaft support member 44 is configured as a cylindrical member having a large-diameter portion 44a and a small-diameter portion 44b that are monolithically formed. The shaft support member 44 may be formed of various kinds of metal materials or resin materials. For example, the shaft support member 44 may be formed by cutting a brass base material in a desired form, and by nickel plating the resulting member.

The large-diameter portion 44a is surrounded by the ring-shaped wall portion 4e. The large-diameter portion 44a is fit into a through hole 4g formed in the base 4 with the rotational axis R as its center axis. Specifically, the large-diameter portion 44a is fixed to the through hole 4g by means of adhesion. The small-diameter portion 44b is provided above the large-diameter portion 44a, and is configured to have a diameter that is smaller than that of the large-diameter portion 44a. The small-diameter portion 44b may be formed such that its maximum radial thickness, i.e., the thickness T1, is less than half of the maximum radial thickness of the large-diameter portion 44a, i.e., the thickness T2. With the present embodiment, the shaft support member 44 is formed such that the thickness T1 of the small-diameter portion 44b is equal to half of the thickness T2 of the large-diameter portion 44a.

The small-diameter portion 44b is surrounded by the surrounding portion 28b via a cylindrical gap 80. In other words, a ring-shaped recess portion 82 is configured above the shaft support member 44 such that it is recessed radially inward. The surrounding portion 28b is configured such that a protruding portion 28k, which is a radially inner-side portion of the surrounding portion 28b, protrudes toward the recess portion 82 so as to surround the shaft support member 44 via the gap 80. The gap 80 is arranged radially inward from the outer face 52a of the flange 52. That is to say, the hub 28 and the shaft support member 44 are configured such that the gap 80 is positioned radially inward from the outer face 52a of the flange 52.

The upper end of the gap 80 communicates with the gas side of the gas-liquid interface 49 of the lubricant agent 48. The lower end of the gap 80 communicates with a motor internal structure space 84 defined between the hub 28 and the base 4. The gap 80 suppresses migration of the vapor of the lubricant agent 48 that has evaporated from the gas-liquid interface 49. This suppresses the leakage of the vapor of the lubricant agent 48 to the outside of the motor internal structure space 84 via the gap 80 and the motor internal structure space 84. As a result, such an arrangement prevents the vapor of the lubricant agent 48 from reaching the magnetic recording disk 8. That is to say, the gap 80 functions as a labyrinth seal.

With such an arrangement, the labyrinth sealing efficiency of the gap 80 becomes higher as the radial cross-sectional area of the gap 80 becomes smaller. With the present embodiment, as described above, the gap 80 is positioned radially inward from the outer face 52a of the flange 52. Thus, the gap 80 is configured to have a relatively small outer diameter. This allows the gap 80 to have a small cross-sectional area. Specifically, by configuring the gap 80 to have a small outer diameter (and a small inner diameter), the cross-sectional area of the gap 80 is reduced. Thus, such an arrangement allows the gap 80 to have a small cross-sectional area while maintaining approximately the same degree of thickness as that of conventional arrangements.

For example, the gap 80 may preferably be configured to have an outer diameter of 6.89 mm, and a radial gap width (gap size) of 0.1 mm or less. This is because the gap 80 thus configured functions as a labyrinth seal with sufficient efficiency. Furthermore, in order to prevent the hub 28 and the shaft support member 44 from coming in contact with each other, the gap 80 may preferably be configured to have a radial gap width of 0.03 mm or more.

The small-diameter portion 44b has a tapered portion 44g at the upper end thereof. A tapered sealing portion 70 is formed between the tapered portion 44g and the shaft 26 such that a gap 72 defined between an inner face 44h of the tapered portion 44g and a facing portion 26b, which is a part of the outer face 26a of the shaft 26 that faces the tapered portion 44g, gradually extends outward as it approaches the upper side. Specifically, the inner face 44h of the tapered portion 44g and the facing portion 26b are each configured such that their diameters become smaller as they approach the upper side. Furthermore, the inner face 44h of the tapered portion 44g and the facing portion 26b are each configured such that the diameter of the inner face 44h of the tapered portion 44g becomes smaller at a rate that is smaller than that with which the diameter of the facing portion 26b becomes smaller. Thus, such an arrangement provides the tapered sealing portion 70 with a tapered shape. When the shaft 26 is rotated, an outward force in the radial direction is applied to the lubricant agent 48 within the tapered sealing portion 70 due to centrifugal force. Because the tapered portion 44g is configured such that its inner face 44h has a diameter that is smaller as it approaches the upper side, the force is applied to the lubricant agent 48 such that it is drawn downward. Furthermore, the tapered sealing portion 70 is configured to have the gas-liquid interface 49 of the lubricant agent 48. This prevents the lubricant agent 48 from leaking out using the capillary action.

The large-diameter portion 44a has three lower faces, i.e., an inner-side lower face 44c, an intermediate lower face 44d, and an outer-side lower face 44e, arranged radially in this order from the inner side. The intermediate lower face 44d is configured such that it is positioned below the inner-side lower face 44c. Furthermore, the outer-side lower face 44e is configured such that it is positioned below the intermediate lower face 44d. The counter plate 54 is fixed to the intermediate lower face 44d of the large-diameter portion 44a by adhesion such that it covers the lower side of the shaft support member 44. A flange space 60 is formed between the upper face 54a of the counter plate 54 and the inner-side lower face 44c of the large-diameter portion 44a, which houses the flange 52. The upper face 52b of the flange 52 and the inner-side lower face 44c are arranged such that they face each other axially via a first thrust gap 57 having a circular form. Furthermore, the lower face 52c of the flange 52 and the counter plate 54 are arranged such that they face each other axially via a second thrust gap 58 having a disk-shaped form.

A gap defined by the shaft 26 and the flange 52, which are configured as a part of the rotor, and the shaft support member 44 and the counter plate 54, which are configured as a part of the stator, is filled with the lubricant agent 48. The lubricant agent 48 contains a fluorescent material. When light such as ultraviolet light is irradiated to the lubricant agent 48, the lubricant agent 48 emits light having a wavelength that is different from the incident light, e.g., blue or green light, due to the interaction between the fluorescent material and the incident light. With such an arrangement in which the lubricant agent 48 includes such a fluorescent material, this allows the liquid surface of the lubricant agent 48 to be monitored in a simpler manner. Furthermore, such an arrangement allows the adhesion or leakage of the lubricant agent 48 to be detected in a simple manner.

The radial gap 53 includes two radial dynamic pressure generating portions 61 and 62 configured to apply radial dynamic pressure to the lubricant agent 48 when the shaft 26 is rotated with respect to the shaft support member 44. The two radial dynamic pressure generating portions 61 and 62 are arranged as separate portions at a predetermined interval along the axial direction. Specifically, the first radial dynamic pressure generating portion 61 is arranged above the second radial dynamic pressure generating portion 62. After the magnetic recording disk 8 is mounted on the hub 28, the center of gravity G of the rotor is positioned between the two radial dynamic pressure generating portions 61 and 62 along the axial direction, i.e., within the bearing span.

A first radial dynamic pressure generating groove 50 and a second radial dynamic pressure generating groove 51, each having a herringbone structure or a spiral structure, are formed at the respective portions of the inner face 44f of the shaft support member 44 that correspond to the two radial dynamic pressure generating portions 61 and 62. It should be noted that at least one of the first radial dynamic pressure generating groove 50 and the second radial dynamic pressure generating groove 51 may be formed in the outer face 26a of an intermediate portion of the shaft 26, instead of the inner face 44f of the shaft support member 44.

The first thrust gap 57 includes a first thrust dynamic pressure generating portion 63 configured to apply axial dynamic pressure to the lubricant agent 48 when the shaft 26 is rotated with respect to the shaft support member 44. A first thrust dynamic pressure generating groove 55 having a herringbone structure or a spiral structure is formed at a portion of the upper face 52b of the flange 52 that corresponds to the first thrust dynamic pressure generating portion 63. Also, the first thrust dynamic pressure generating groove 55 may be formed in the inner-side lower face 44c of the shaft support member 44, instead of the upper face 52b of the flange 52.

The second thrust gap 58 includes a second thrust dynamic pressure generating portion 64 configured to apply axial dynamic pressure to the lubricant agent 48 when the shaft 26 is rotated with respect to the shaft support member 44. A second thrust dynamic pressure generating groove 56 having a herringbone structure or a spiral structure is formed at a portion of the lower face 52c of the flange 52 that corresponds to the second thrust dynamic pressure generating portion 64. Also, the second thrust dynamic pressure generating groove 56 may be formed in the upper face 54a of the counter plate 54, instead of the lower face 52c of the flange 52.

When the rotor is rotated relative to the stator, dynamic pressure is applied to the lubricant agent 48 by means of the first radial dynamic pressure generating groove 50, the second radial dynamic pressure generating groove 51, the first thrust dynamic pressure generating groove 55, and the second thrust dynamic pressure generating groove 56. By applying such dynamic pressure thus generated, the rotor is supported in a contactless manner both radially and axially.

Description will be made regarding the operation of the rotating device 100 thus configured as described above. In order to rotationally drive the magnetic recording disk 8, a three-phase driving current is supplied to the coil 42. When the driving current flows through the coil 42, a magnetic flux occurs along each of the twelve salient poles. The magnetic flux thus generated provides a torque to the cylindrical magnet 32, thereby rotationally driving the hub 28 and the magnetic recording disk 8 fitted to the hub 28. At the same time, the swing arm 14 is swung by means of the voice coil motor 16, so as to swing back and forth the record and playback head in the swinging range above the magnetic recording disk 8. The record and playback head is configured to convert magnetic data recorded on the magnetic recording disk 8 into an electrical signal, and to transmit the electric signal thus converted to a control board (not shown). Furthermore, the record and playback head receives data transmitted in the form of an electric signal from the control board, and writes the data thus received on the magnetic recording disk 8 in the form of magnetic data.

With the rotating device 100 according to the present embodiment, the gap 80 is configured such that it is positioned radially inward from the outer face 52a of the flange 52. This allows the gap 80 to have a relatively small outer diameter. Thus, such an arrangement allows the gap 80 to have a small cross-sectional area, thereby improving the efficiency of the labyrinth seal. As a result, such an arrangement suppresses contamination of the magnetic recording disk 8 due to evaporated lubricant agent 48. In addition, such an arrangement relaxes the reduction in the lubricant agent 48 with the passage of time, thereby improving the reliability and life of the rotating device 100.

Furthermore, with the rotating device 100 according to the present embodiment, the laminated core 40 is configured such that the radial thickness of the circular portion 40a and the ratio of the circumferential thickness t1 of each intermediate portion 40c with respect to the outer diameter D11 of the circular portion 40a are greater than those of the laminated core 140 according to the comparison example. This reduces mechanical vibration arising from cogging torque.

In a case in which the cylindrical magnet 32 and each salient pole 40b are arranged at a small interval, in some cases, such an arrangement leads to an increase in mechanical vibration arising from cogging torque. In contrast, by configuring the laminated core 40 as described above, such an arrangement is capable of reducing vibration arising from cogging torque. Thus, with the rotating device 100 according to the present embodiment, such an arrangement allows the gap defined between the cylindrical magnet 32 and each salient pole 40b to be reduced while suppressing an increase in vibration arising from cogging torque. In a case in which the gap between the cylindrical magnet 32 and each salient pole 40b is reduced, such an arrangement is capable of increasing the magnetic flux received by the laminated core 40. Thus, even in a case in which the cylindrical magnet 32 is configured to have a radially and axially reduced size, such an arrangement is capable of providing a torque with approximately the same magnitude as that provided by conventional arrangements, without a need to increase the driving current. That is to say, with the rotating device 100 according to the present embodiment, such an arrangement allows the size of the cylindrical magnet 32 to be reduced while maintaining the torque at the same level, thereby providing a reduced cost.

If the peak frequency of the torque spectrum approximately matches the resonance frequency of the secondary locking mode (which will be referred to as the “secondary locking mode resonance” hereafter), large vibration occurs in the rotating device 100 due to resonance. As a method for avoiding frequency matching, a method is conceivable in which the resonance frequency of the secondary locking mode is raised. As a factor which determines the secondary locking mode resonance frequency, the transverse moment of inertia of the hub 28 is known. Specifically, by reducing the transverse moment of inertia of the hub 28, the secondary locking mode resonance frequency can be raised. The transverse moment of inertia of the hub 28 is determined by the mass of the hub 28 and the mass of the cylindrical magnet 32 fixed to the hub 28. Thus, by reducing the masses of these components, the secondary locking mode resonance frequency can be raised. With the rotating device 100 according to the present embodiment, such an arrangement allows the cylindrical magnet 32 to have a relatively small size, i.e., to have a relatively small mass. Thus, such an arrangement allows the secondary locking mode resonance frequency to be raised, thereby avoiding frequency matching between the torque ripple and the secondary locking mode resonance.

Furthermore, with the rotating device 100 according to the present embodiment, after the magnetic recording disk 8 is mounted on the hub 28, the center of gravity G of the rotor is within the bearing span. This provides stable rotation of the rotor.

In order to confirm the vibration reducing effect of the laminated core 40, the present inventors performed experiments using the rotating device 100 including the laminated core 40 and a rotating device according to the comparison example including the laminated core 140. Specifically, an acceleration sensor was mounted on the base of each rotating device. With such an arrangement, each rotating device was rotationally driven. In this state, the output of each acceleration sensor was measured. The output data thus measured was subjected to frequency analysis so as to derive a vibration spectrum. The dimensions of the laminated cores 40 and 140 will be listed below.

### [Laminated Core 40 According to the Present Embodiment]

Outer diameter D11 of the circular portion 40a: 20.14 mm

Inner diameter D12 of the circular portion 40a: 15.02 mm

Circumferential thickness t1 of the intermediate portion 40c: 2.9 mm

Outer diameter D13 of the end portion 40d: 28.74 mm

Outer diameter D14 of the intermediate portion 40c: 27 mm

Number of laminated electromagnetic steel sheets: 7

### [Laminated Core 140 According to the Comparison Example]

Outer diameter D21 of the circular portion 140a: 18.45 mm

Inner diameter D22 of the circular portion 140a: 15.46 mm

Circumferential thickness t2 of the intermediate portion 140c: 2.4 mm

Outer diameter D23 of the end portion 140d: 27.475 mm

Outer diameter D24 of the intermediate portion 140c: 25.4 mm

Number of laminated electromagnetic steel sheets: 8

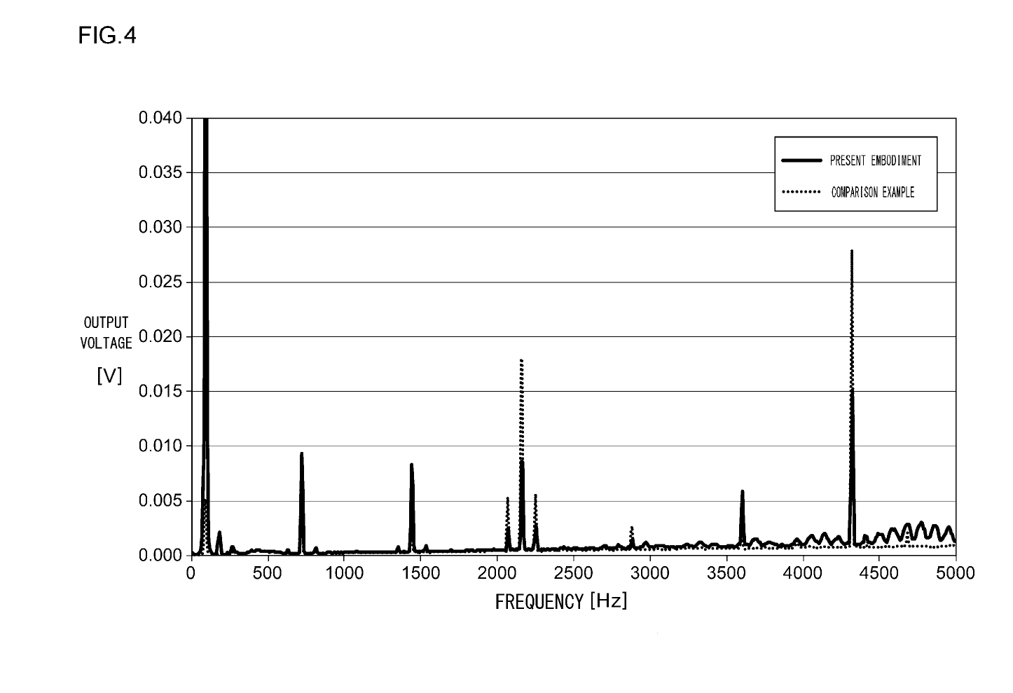

FIG. 4 shows vibration spectrums respectively obtained by rotationally driving the rotating device 100 and the rotating device according to the comparison example with revolutions N=90 (Hz) (5400 (rpm)). In FIG. 4, the horizontal axis represents the frequency, and the vertical axis represents the frequency components of the output voltage output from each acceleration sensor. Referring to FIG. 4, the output voltage was approximately 0.0086 (V) with the rotating device 100, and the output voltage was approximately 0.018 (V) with the rotating device according to the comparison example, at the 24-th order high-frequency component (2160 (Hz)), which is the major frequency component of cogging torque, and the order of which is derived as the lowest common multiple of the number of salient poles of the laminated core 40 (140), i.e., 12, and the number of magnetic poles of the cylindrical magnet 32, i.e., 8.

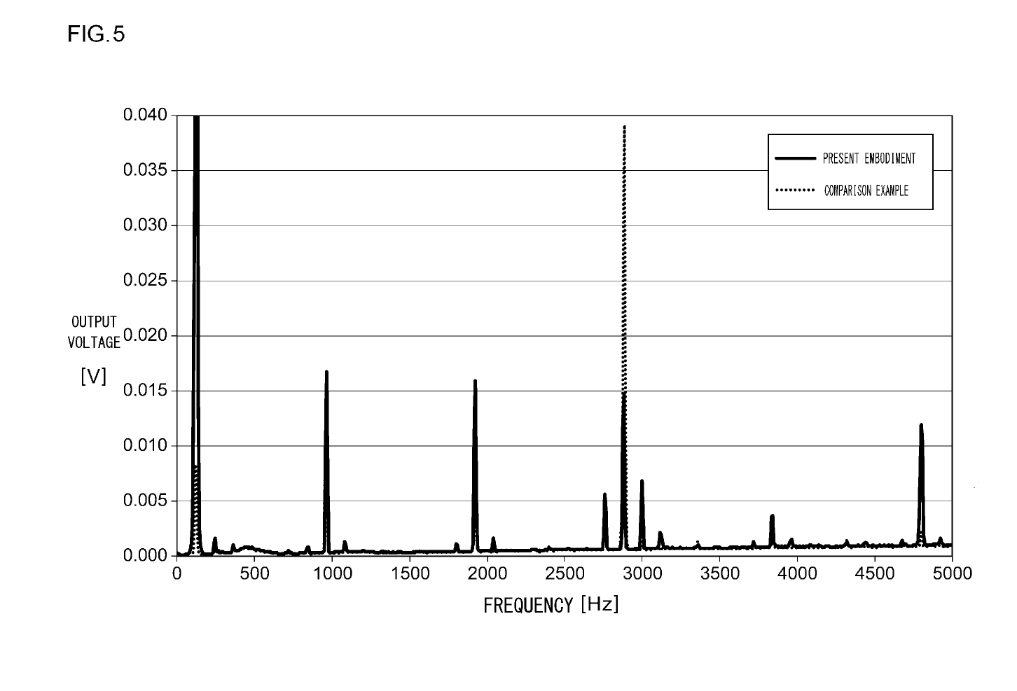

FIG. 5 shows vibration spectrums respectively obtained by rotationally driving the rotating device 100 and the rotating device according to the comparison example with revolutions N=120 (Hz) (7200 (rpm)). FIG. 5 corresponds to FIG. 4. Referring to FIG. 5, at the 24-th order high-frequency component (2880 (Hz)), the output voltage was approximately 0.015 (V) with the rotating device 100, and the output voltage was approximately 0.039 (V) with the rotating device according to the comparison example.

Based on the aforementioned experiment results, it has been confirmed that the rotating device 100 including the laminated core 40 is capable of suppressing vibration arising from cogging torque as compared with the rotating device according to the comparison example including the laminated core 140.

### Second Embodiment

The major difference between the rotating device 100 according to the first embodiment and a rotating device according to a second embodiment is a fixation method for fixing the hub.

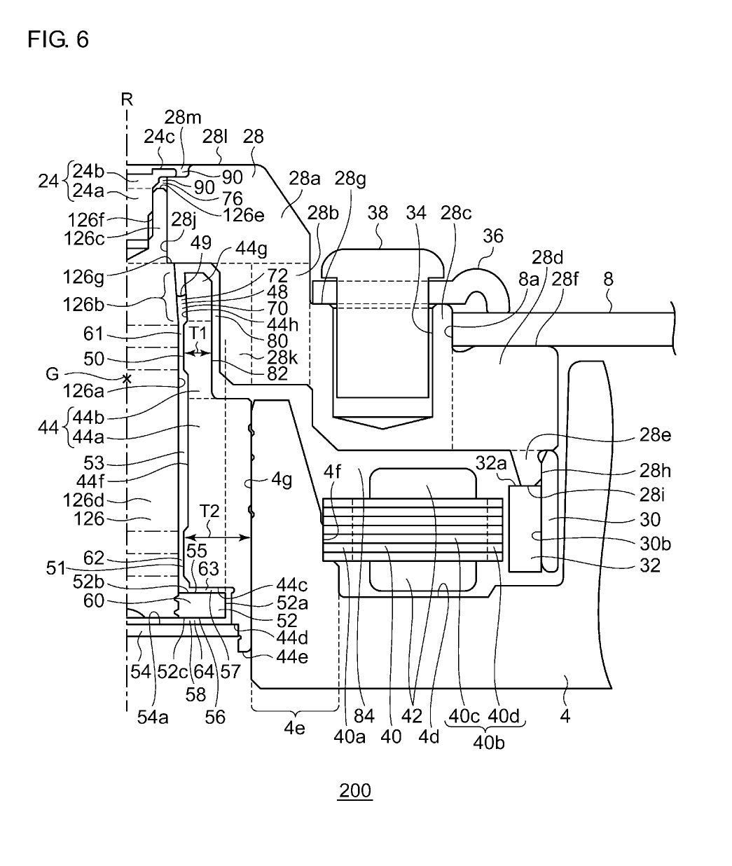

FIG. 6 is a cross-sectional view of a rotating device 200 according to the second embodiment. FIG. 6 corresponds to FIG. 2.

A shaft 126 includes a shaft small-diameter portion 126c as its upper portion, and a shaft large-diameter portion 126d as its lower portion arranged below the shaft small-diameter portion 126c, and configured to have a diameter that is greater than that of the shaft small-diameter portion 126c. A hub fixation screw hole 126f, which is not a through-hole, is formed in the upper face 126e of the shaft small-diameter portion 126c along the rotational axis R.

The shaft 126 is inserted into the hole 28j formed in the shaft fixation portion 28a of the hub 28, and is fixed to the hub 28 by means of press fitting and adhesion. Furthermore, the hub 28 is fixed to the shaft 126 by means of a hub fixation screw 24. The hub fixation screw 24 includes a small-diameter portion 24a which is fit to the hub fixation screw hole 126f, and a large-size portion 24b having a size that is larger than that of the small-diameter portion 24a. By screwing the hub fixation screw 24 into the hub fixation screw hole 126f, the shaft fixation portion 28a is fixed in a state in which the edge of the hole 28j is interposed between the large-size portion 24b of the hub fixation screw 24 and the upper face 126g of the shaft large-diameter portion 126d. As described above, the hub 28 is fixed to the shaft 126 by means of the hub fixation screw 24 in addition to the adhesion and press fitting. Thus, such an arrangement allows the hub 28 to be bonded to the shaft 126 with sufficient strength.

A hub recessed portion 28m is formed in the upper face 281 of the shaft fixation portion 28a such that it is recessed downward. In a state in which the hub 28 is fixed to the shaft 126 after the hub fixation screw 24 is screwed into the hub fixation screw hole 126f, the large-size portion 24b is housed in the hub recessed portion 28m. Specifically, the large-size portion 24b is housed in the hub recessed portion 28m such that its upper face 24c does not exceed and does not protrude from the upper face 281 of the shaft fixation portion 28a.

In order to prevent the detachment of the hub fixation screw 24, at least one of the gap between the hub fixation screw 24 and the hub fixation screw hole 126f and the gap between the large-size portion 24b and the shaft small-diameter portion 126c (circumferential space 76) may be filled with the adhesive agent 90. For example, in a case in which both gaps are filled with the adhesive agent 90, a suitable amount of the adhesive agent 90 may be applied to the circumferential face of the hub fixation hole 126f and the upper face 126e of the shaft small-diameter portion 126c before the hub fixation screw 24 is screwed in, thereby filling both gaps with the adhesive agent 90. Also, the hub recessed portion 28m may be filled with the adhesive agent 90. In this case, the adhesive agent is applied to the hub recessed portion 28m before or otherwise after the hub fixation screw 24 is screwed in, thereby filling the hub recessed portion 28m with the adhesive agent 90. It should be noted that FIG. 6 shows a case in which all the gaps and the hub recessed portion 28m are filled with the adhesive agent 90.

The hub fixation screw 24 may be formed of various kinds of metal materials. For example, the hub fixation screw 24 may be formed by cutting or rolling a steel material such as SUS410 or the like having substantially the same linear expansion coefficient as that of the shaft 126. In this case, such an arrangement suppresses the occurrence of stress due to the difference in the linear expansion coefficient. In particular, such an arrangement suppresses the occurrence of cracks or plastic deformation in the hub fixation screw 24 or the shaft 126.

Description has been made in the present embodiment with reference to the rotating device 200 regarding an arrangement in which the hub fixation screw 24 is screwed into the hub fixation screw hole 126f. However, the present invention is not restricted to such an arrangement. For example, instead of the hub fixation screw 24, another kind of fastener may be fit into a hub fixation hole that corresponds to the hub fixation screw hole 126f, so as to provide the fixation. As such a fastener, known coupling mechanisms may be employed, examples of which include swaging pins, eyelets, rivets, etc. Such an arrangement allows the step for forming the screw hole to be omitted.

The rotating device 200 according to the present embodiment provides the same advantages and effects as those provided by the rotating device 100 according to the first embodiment. Furthermore, with the rotating device 200 according to the present embodiment, the hub 28 is fixed to the shaft 126 by means of the hub fixation screw 24 in addition to the combination of adhesion and press fitting. This allows the hub 28 to be fixed to the shaft 126 with sufficiently high strength even if the connection that connects them is configured to have a relatively small axial length. That is to say, such an arrangement allows the shaft fixation portion 28a to have a relatively small width in the axial direction. This allows the upper portion of the hub 28 to have a small mass. As a result, such an arrangement allows the rotor to be arranged with the center of gravity G being at a relatively low level. This allows the center of gravity G to be positioned within the bearing span in a sure manner.

Description has been made regarding the configurations and the operations of the rotating devices according to the embodiments. The above-described embodiments have been described for exemplary purposes only, and are by no means intended to be interpreted restrictively. Rather, it can be readily conceived by those skilled in this art that various modifications may be made by making various combinations of the aforementioned components, which are also encompassed in the technical scope of the present invention.

Description has been made in the embodiment regarding a so-called outer rotor type rotating device having a configuration in which the cylindrical magnet is arranged on the outer side of the laminated core. However, the present invention is not restricted to such an arrangement. For example, the technical idea of the present invention may be applied to a so-called inner rotor type rotating device having a configuration in which a cylindrical magnet is arranged on the inner side of the laminated core.

Description has been made in the embodiment regarding an arrangement in which the shaft support member is directly mounted on the base. However, the present invention is not restricted to such an arrangement. For example, a brushless motor comprising a rotor and a stator may be formed separately. Also, an arrangement may be made in which the brushless motor thus formed is mounted on a chassis.

Description has been made in the embodiment regarding an arrangement employing a laminated core. However, the core thus employed is not restricted to such a laminated core. Description has been made in the embodiment regarding an arrangement in which the laminated core 40 includes twelve salient poles. However, the present invention is not restricted to such an arrangement. The number of salient poles of the laminated core 40 may be six or nine, for example. Such an arrangement allows the coil 42 to be formed in a simpler manner. Also, the number of salient poles of the laminated core 40 may be a multiple of 3 ranging between 15 and 36, for example. Such an arrangement provides the coil 42 with an increased number of turns.

Description has been made in the embodiment regarding an arrangement in which the laminated core is formed by laminating seven thin magnetic steel sheets each having a thickness of 0.35 mm. However, the present invention is not restricted to such an arrangement. Also, the laminated core may be formed by laminating 2 to 32 thin magnetic steel sheets each having a thickness ranging between 0.1 mm and 0.8 mm, for example.

Description has been made in the embodiment regarding an arrangement in which the cylindrical magnet 32 is configured such that 8 driving magnetic poles are formed. However, the present invention is not restricted to such an arrangement. Also, the number of driving magnetic poles formed on the cylindrical magnet 32 may be an even number ranging between 10 and 16. This allows the magnetic poles to be formed in a simpler manner. Also, the number of driving magnetic poles formed on the cylindrical magnet 32 may be an even number ranging between 18 and 24. In this case, the number of salient poles of the laminated core 40 may be increased, thereby allowing the number of turns of the coil 42 to be increased. Description has been made above for exemplary purposes only. That is to say, the number of driving magnetic poles is not restricted to such a range.

The base 4 may be configured by making a combination of a base portion formed by pressing a metal plate such as an aluminum plate, an iron plate, or the like, and a die-cast portion formed of aluminum by die casting. For example, the bottom portion 4a may be configured including such a plate portion. Also, the outer wall portion 4b may be configured including such a die-cast portion. Such a configuration suppresses degradation of the rigidity of the screw hole 22. Examples of a method for manufacturing such a base 4 include a method whereby the die-cast portion is formed by means of aluminum die casting in a state in which such a plate portion formed beforehand is mounted on an aluminum die-cast base. Such a manufacturing method allows the bonding between the plate portion and the die-cast portion to be formed in a simpler manner. Furthermore, such a method allows the plate portion and the die-cast portion to have an improved size precision. Also, such a method allows an additional member for connecting the plate portion and the die-cast portion to be configured with a reduced size. Alternatively, such a method allows the plate portion and the die-cast portion to be connected without such an additional member. As a result, such an arrangement allows the base 4 to be configured to have a small thickness.

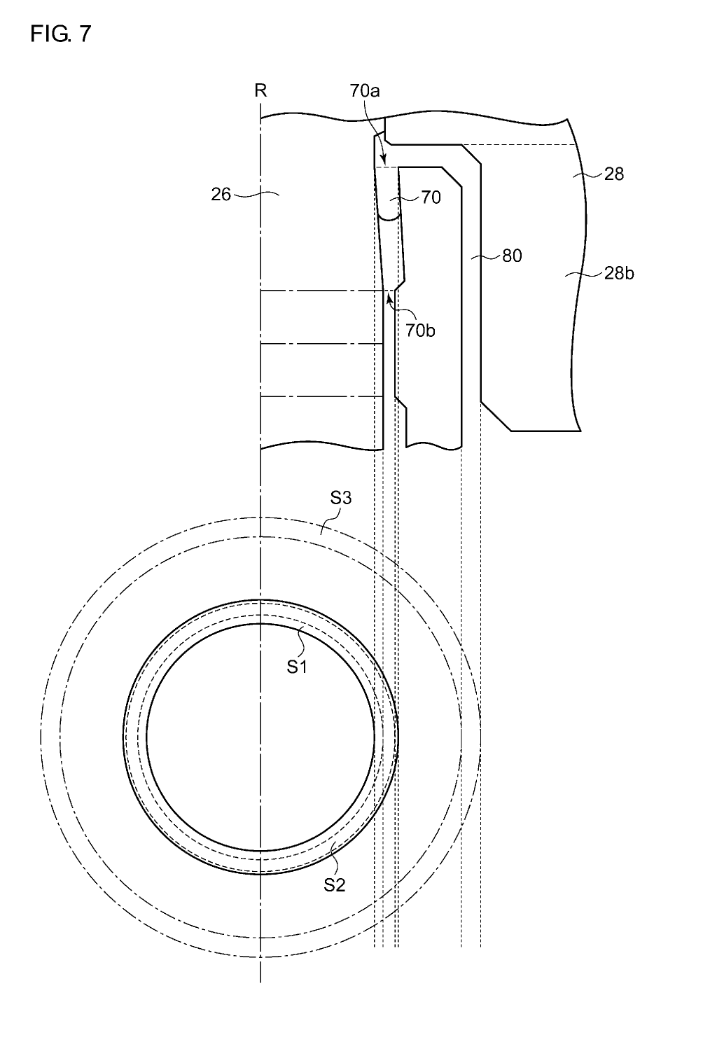

Next, description will be made with reference to FIG. 7 regarding the structure of the tapered sealing portion 70 and the gap 80 according to the first embodiment. The upper part of FIG. 7 is a cross-sectional view showing the tapered sealing portion 70 and the gap 80. The lower part of FIG. 7 is a projection view obtained by projecting, onto a plane that is orthogonal to the rotational axis R, the gap 70a at the top portion (widest portion) of the tapered sealing portion 70, the gap 70b at the bottom portion (narrowest portion) of the tapered sealing portion 70, and the narrowest portion of the gap 80.

Examples of dimensions of the tapered sealing portion 70 and the gap 80 will be listed below.

### [Tapered Sealing Portion 70]

Central diameter of the gap at the top portion 70a: 4.0 mm

Width of the gap at the top portion 70a: 0.29 mm

Cross-sectional area S1 of the gap at the top portion 70a (which corresponds to the area enclosed by the solid line shown in the lower part of FIG. 7): 3.68 mm²

Central diameter of the gap at the bottom portion 70b: 3.96 mm

Width of the gap at the bottom portion 70b: 0.004 mm

Cross-sectional area S2 of the gap at the bottom portion 70b (which corresponds to the area enclosed by the broken line shown in the lower part of FIG. 7): 0.05 mm² [Gap 80]

Central diameter of the gap 80: 6.9 mm

Average width of the gap 80: 0.07 mm

Cross-sectional area S3 of the gap 80 at the narrowest portion (which corresponds to the area enclosed by the line of dashes and dots shown in the lower part of FIG. 7): 1 to 2 mm²

That is to say, the gap 80 is configured such that its cross-sectional area S3 at the narrowest portion is within a range between approximately ¼ and approximately ½ of the sum of the cross-sectional area S1 of the gap of the tapered sealing portion 70 at the top portion 70a and the cross-sectional area S2 of the gap at the bottom portion 70b. Such an arrangement is capable of further suppressing migration of the vapor of the lubricant agent 48 via the gap 80 as compared with an arrangement having the cross-sectional area S3 that is greater than the aforementioned range. Furthermore, such an arrangement provides the gap 80 with a large width as compared with an arrangement having a cross-sectional area C that is smaller than the aforementioned range. Thus, such an arrangement simplifies the manufacturing.

What is claimed is:

1. A rotating device comprising:
a rotor comprising:
a hub on which a magnetic recording disk is to be mounted;
a shaft extending along a rotational axis of the hub, one side of the shaft being fixed to the hub; and
a flange surrounding the other side of the shaft, the flange being fixed to the shaft; and
a bearing body surrounding and rotatably supporting the shaft,
wherein a space defined between the shaft and the bearing body is provided with a radial dynamic pressure generating portion, a holding space in which a lubricant agent is to be held, and a tapered space which has a width that becomes greater toward said one side and which is communicated with the holding space,
wherein the bearing body comprises an annular portion located in an end of the bearing body on said one side, an outer peripheral surface of the annular portion being recessed radially inward,
wherein the hub comprises a surrounding portion surrounding the annular portion, and
wherein a communicating gap defined by the surrounding portion and the bearing body communicates with said one side of the tapered space, the communicating gap being positioned radially inward from an outer face of the flange.

2. The rotating device according to claim 1, further comprising a base provided with a hole into which the bearing body is inserted,
wherein the bearing body comprises a large-diameter portion having a diameter that is greater than that of the annular portion, the large-diameter portion surrounding the flange and being fitted and fixed to the hole.

3. The rotating device according to claim 2, wherein a radial thickness of the annular portion is less than half a radial thickness of the large-diameter portion.

4. The rotating device according to claim 1, wherein a radial dimension of the communicating gap is within a range that is equal to or greater than 0.03 mm and is equal to or smaller than 0.1 mm.

5. The rotating device according to claim 1, wherein a thrust dynamic pressure generating portion is provided in a gap between the flange and a member that axially faces the flange.

6. The rotating device according to claim 1, wherein the radial dynamic pressure generating portion comprises two portions arranged at an interval along a shaft extending direction, and
wherein the rotor is configured such that a center of gravity of the rotor having the magnetic recording disk mounted thereon is positioned between the two portions.

7. The rotating device according to claim 1, wherein the communicating gap surrounds the tapered space and a part of the radial dynamic pressure generating portion.

8. A rotating device comprising:
a rotor comprising:
a hub on which a magnetic recording disk is to be mounted; and
a shaft extending along a rotational axis of the hub, one side of the shaft being fixed to the hub; and
a bearing body surrounding and rotatably supporting the shaft,
wherein a space defined between the shaft and the bearing body is provided with a radial dynamic pressure generating portion, a holding space in which a lubricant agent is to be held, and a tapered space which has a width that becomes greater toward said one side and which is communicated with the holding space,
wherein the bearing body comprises an annular portion located in an end of the bearing body on said one side, an outer peripheral surface of the annular portion being recessed radially inward,
wherein the hub comprises a surrounding portion surrounding the annular portion,
wherein a communicating gap defined by the surrounding portion and the bearing body communicates with said one side of the tapered space, and
wherein the annular portion axially passes through a center hole of the magnetic recording disk.

9. The rotating device according to claim 8, wherein the rotor comprises a flange surrounding the other side of the shaft, the flange being fixed to the shaft,
wherein a thrust dynamic pressure generating portion is provided in a gap between the flange and a member that axially faces the flange, and
wherein the communicating gap is positioned radially inward from an outer face of the flange.

10. The rotating device according to claim 9, further comprising a base provided with a hole into which the bearing body is inserted,
wherein the bearing body comprises a large-diameter portion having a diameter that is greater than that of the annular portion, the large-diameter portion surrounding the flange and being fitted and fixed to the hole.

11. The rotating device according to claim 10, wherein a radial thickness of the annular portion is less than half a radial thickness of the large-diameter portion.

12. The rotating device according to claim 8, wherein a radial dimension of the communicating gap is within a range that is equal to or greater than 0.03 mm and is equal to or smaller than 0.1 mm.

13. The rotating device according to claim 8, wherein the radial dynamic pressure generating portion comprises two portions arranged at an interval along a shaft extending direction, and
wherein the rotor is configured such that a center of gravity of the rotor having the magnetic recording disk mounted thereon is positioned between the two portions.

14. The rotating device according to claim 8, wherein the communicating gap surrounds the tapered space and a part of the radial dynamic pressure generating portion.

15. A rotating device comprising:
a rotor comprising:
a hub on which a magnetic recording disk is to be mounted; and
a shaft extending along a rotational axis of the hub, one side of the shaft being fixed to the hub; and
a bearing body surrounding and rotatably supporting the shaft,
wherein a space defined between the shaft and the bearing body is provided with a radial dynamic pressure generating portion, a holding space in which a lubricant agent is to be held, and a tapered space which has a width that becomes greater toward said one side and which is communicated with the holding space,
wherein the bearing body comprises an annular portion located in an end of the bearing body on said one side, an outer peripheral surface of the annular portion being recessed radially inward,
wherein the hub comprises a surrounding portion surrounding the annular portion,
wherein a communicating gap defined by the surrounding portion and the bearing body communicates with said one side of the tapered space, and
wherein the communicating gap surrounds the tapered space.

16. The rotating device according to claim 15, wherein the rotor comprises a flange surrounding the other side of the shaft, the flange being fixed to the shaft,
wherein a thrust dynamic pressure generating portion is provided in a gap between the flange and a member that axially faces the flange, and
wherein the communicating gap is positioned radially inward from an outer face of the flange.

17. The rotating device according to claim 16, further comprising a base provided with a hole into which the bearing body is inserted, and
wherein the bearing body comprises a large-diameter portion having a diameter that is greater than that of the annular portion, the large-diameter portion surrounding the flange and being fitted and fixed to the hole.

18. The rotating device according to claim 17, wherein a radial thickness of the annular portion is less than half a radial thickness of the large-diameter portion.

19. The rotating device according to claim 15, wherein a radial dimension of the communicating gap is within a range that is equal to or greater than 0.03 mm and is equal to or smaller than 0.1 mm.

20. The rotating device according to claim 15, wherein the radial dynamic pressure generating portion comprises two portions arranged at an interval along a shaft extending direction, and
wherein the rotor is configured such that a center of gravity of the rotor having the magnetic recording disk mounted thereon is positioned between the two portions.
